(19) United States
(12) Patent Application Publication
(10) Pub. No.: US 2023/0212356 A1
(43) Pub. Date: Jul. 6, 2023

(54) SULFUR-CONTAINING MATERIAL AND USE THEREOF

(71) Applicant: Cytec Industries Inc., Princeton, NJ (US)

(72) Inventor: Jonathan Edward MEEGAN, Chester (GB)

(73) Assignee: Cytec Industries Inc., Princeton, NJ (US)

(21) Appl. No.: 18/008,733

(22) PCT Filed: Jun. 11, 2021
(86) PCT No.: PCT/US2021/037026

§ 371 Date: Dec. 7, 2022

Related U.S. Application Data
(60) Provisional application No. 63/038,291, filed on Jun. 12, 2020.

(51) Int. Cl. C08G 75/14; C08L 81/04

(52) U.S. Cl. CPC C08G 75/14; C08L 81/04

(57) ABSTRACT

A sulfur reaction product formed by reacting elemental sulfur with an amine or epoxy compound containing reactive functionality. Such reaction product can be incorporated into a thermosettable resin composition as a modifier. When the thermosettable composition containing such sulfur reaction product is cured, the resulting crosslinked thermoset displays improved stress relaxation characteristics in line with vitrimer like behaviors.

The present disclosure relates generally to sulfur-containing materials and their applications.

### BRIEF DESCRIPTION OF THE DRAWINGS

FIG. 1 shows the relative relaxation modulus of a thermoset material modified with different amounts of diaminodiphenyl sulfide as a function of temperature.

FIG. 2 shows the relative relaxation modulus of a thermoset material modified with different amounts of sulfur-MDEA reaction product as a function of temperature.

FIG. 3 shows the relative relaxation modulus of a thermoset material modified with different amounts of sulfur-DGEBF (sulfur-PY306) reaction product as a function of temperature.

### DETAILED DESCRIPTION

Composite materials composed of reinforcing fibres embedded in a thermoset resin matrix have been used in the manufacture of load-bearing components suitable for use in transport applications (including aerospace, aeronautical, nautical and land vehicles) and in building/construction applications. To form structural parts from composite materials, the materials must be shaped and cured. Once cured, thermoset composite materials become irreversibly hardened and cannot be reshaped. Recycling of the polymer component (or matrix) of the cured thermoset composite material is challenging. Conventional recycling methods involve thermal or chemical degradation of the polymer matrix to yield recyclable elements which can be separated from the fiber recyclate.

One attempt to provide reprocessable epoxide composites is to mix an epoxy resin with a cross-linking agent of the formula Ar—S—S—Ar where Ar is a ring system from 5 to 14 carbon atoms (see WO15181054 A1). The specific crosslinking agent disclosed in WO15181054 is bis(4-aminophenyl) disulfide (AFD). It was found that the resulting composite produced from using an epoxy resin cross-linked with such AFD crosslinking agent shows the ability of being reprocessable, recyclable and repairable. The disadvantage associated with such use of AFD crosslinking agent is that it is very expensive, making the use thereof impractical for large scale application.

Elemental Sulfur is widely available, low cost material and the polymerization behavior of elemental Sulfur is well known. The S_{5 to 8} Sulfur structure which exists at room temperature undergoes a ring opening reaction to form a di-radical at around 110° C.-120° C.:

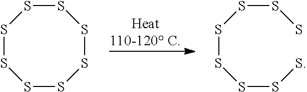

Such di-radical polymerizes to form higher molecular weight (Mw) linear chains at around 150° C.; however, the resulting sulfur polymers are not stable and steadily convert back to the cyclic S_{5 to 8} units over time.

It has been discovered that when elemental sulfur is reacted with certain amine or epoxy compound with reactive functional groups, and that reaction product is introduced into an epoxy-based thermoset material and cured, the cured modified thermoset displays vitrimer like behavior. Vitrimers refer to a class of polymers that have properties of permanently crosslinked thermosets while at the same time retaining processability due to covalently adaptable networks (CAN). When thermally triggered, CAN can undergo exchange reactions of crosslinks, which facilitate polymer network rearrangement, making macroscopic reshaping possible. If a stress is applied to the crosslinks, the crosslinks can rearrange until the stress relaxes and a new shape is obtained. Vitrimer like behavior can be evidenced through the use of stress relaxation experiment in which a material is strained to a fixed length at an isothermal temperature and the relaxation modulus is measured over a fixed time period. By making a relative comparison to the initial relaxation modulus at t=0 in the experiment and t=end, the stress relaxation behavior can be quantified. Vitrimer like behavior in a thermosetting material is advantageous as it theoretically allows for a thermoset network containing vitrimer functionality to be recycled by dissociating the vitrimer bonds.

A sulfur reaction product can be formed by reacting elemental sulfur with an amine having reactive functionality, particularly, an aromatic diamine having at least one, preferably two, reactive amine groups per molecule. A sulfur reaction product can also be formed by reacting elemental sulfur with an epoxy compound, particularly, an epoxide compound having at least one, preferably two, epoxy functional groups per molecule, and a compatibilising agent.

In one embodiment, the sulfur reaction product is formed by reacting elemental sulfur with 4,4′-methylene-bis-(2,6-diethylaniline) (MDEA), hereafter referred to as “sulfur-MDEA” reaction product.

In another embodiment, the sulfur reaction product is formed by reacting elemental sulfur with diglycidyl ether of Bisphenol F (DGEBF), hereafter referred to as “sulfur-DGEBF” reaction product.

It has been found that the sulfur-MDEA reaction product is a homogeneous material in solid state, and sulfur-DGEBF reaction product is a homogeneous material in the form of a paste. Both reaction products are dissolvable in epoxy resins at an elevated temperature. The term “homogeneous” in context means substantially or mostly uniform in composition without any visual inconsistencies.

The sulfur reaction product can be incorporated, as a modifier, into a thermosettable resin composition containing one or more epoxy resins and an amine curing agent. When the thermosettable composition containing such sulfur reaction product is cured, the resulting crosslinked thermoset displays improved stress relaxation characteristics in line with vitrimer like behaviors. Due to the developed vitrimer like characteristics, the cured material has the characteristics of a reprocessable thermoset material.

### Preparation of Reaction Product

The reaction product of sulfur and amine is prepared by mixing sulfur (in powder form) with the amine and heating the mixture to a temperature greater than the melting temperature of the sulfur or the amine (whichever is higher), and holding the heated mixture for a period of time to ensure reaction of the reactive functionalities present on the amine with elemental sulfur. In some embodiments, the reaction temperature is in the range of 120° C. to 200° C., in one embodiment, 140° C. The reaction time is preferably more than 1 hour.

For sulfur-MDEA reaction product, the mass ratio of sulfur to amine may be from 0.01:1 to 1:1, preferably, 0.5:1 or 1:1.

The reaction product of sulfur and epoxy is prepared by mixing sulfur (in powder form) with the epoxy resin and a compatibilising agent, heating the mixture to a temperature greater than the melting temperature of the sulfur, and holding the heated mixture for a period of time to ensure reaction of the reactive functionalities present on the epoxy with elemental sulfur. In some embodiments, the reaction temperature is in the range of 120° C. to 200° C., in one embodiment, 140° C. The reaction time is preferably more than 1 hour.

For sulfur-DGEBF reaction product, the mass ratio of sulfur to epoxy resin may be is from 0.01:1 to 1:1, preferably, 0.5:1 or 1:1. The compatibilising agent is selected from compounds which show evidence of solubility in the heated sulfur mixture, for example, sodium diethyldithiocarbamate (DDC). The amount of accelerator is up to 20 parts in weight, and more preferably 5 parts in weight, per 100 parts in weight of sulfur and DGEBF combined.

### Articles of Manufacture and Manufacturing Methods

The sulfur reaction product disclosed herein may be used in the fabrication of composite materials such as prepregs or to form a polymeric article without fiber reinforcement or used in resin transfer molding or other liquid resin injection or infusion processes.

A prepreg, according to one embodiment of the present disclosure, is composed of a layer of reinforcement fibers fully or partially embedded in a resin or polymer matrix containing the sulfur reaction product as an additive. In another embodiment, the prepreg is composed of a layer of reinforcement fibers embedded in the sulfur reaction product as the polymer matrix.

As used in the present disclosure, the term “embedded” means fixed firmly in a surrounding mass, and the term “matrix” means a mass of material, e.g. resin or polymer, in which something is enclosed or embedded. The term “resin” as used herein refers to monomer, oligomer, or polymer which has not been cured or crosslinked.

For thermoset prepregs, the resin matrix contains one or more uncured thermoset resins and the sulfur reaction product as an additive. Optionally, a curing agent may be included in the resin matrix to react with the resins and to enable crosslinking. The resin matrix in the thermoset prepreg may be in a partially cured or uncured state. The uncured or partially cured prepreg is a pliable or flexible material that is ready for laying up and shaping into a three-dimensional configuration, followed by curing to form a hardened composite part. Consolidation by applying pressure (with or without heat) may be carried out prior to curing to prevent the formation of voids within the layup. This type of thermoset prepregs is particularly suitable for manufacturing load-bearing structural parts, such as wings and fuselages of aircrafts. Important properties of the cured thermoset prepregs are high strength and stiffness with reduced weight.

The term “cure” or “curing” refers to the hardening of a pre-polymer material, a resin or monomers brought about by heating at elevated temperatures. The term “curable” in reference to composition means that the composition is capable of being cured into a hardened or thermoset state.

Suitable thermoset resins for the thermoset resin matrix include, but are not limited to, epoxy resins, imides (such as polyimide or bismaleimide), vinyl ester resins, cyanate ester resins, isocyanate modified epoxy resins, phenolic resins, furanic resins, benzoxazines, formaldehyde condensate resins (such as with urea, melamine or phenol), polyesters, acrylics, hybrids, blends and combinations thereof.

The present disclosure is also directed to methods for fabricating thermoset composite materials. According to one embodiment, the method for fabricating composite materials includes:
(a) adding the sulfur reaction product into an uncured thermoset resin composition;
(b) impregnating a fiber reinforcement layer or infusing a fibrous preform with the resin composition of step (a); and
(c) curing the impregnated fiber reinforcement at an elevated temperature, preferably, for a period of time such that the ratio of the cured reaction enthalpy/uncured reaction enthalpy, as determined by Differential Scanning calorimetry (DSC), is less than 0.1 and preferably less than 0.05.

In this embodiment, the sulfur reaction product is used as an additive, which functions as a modifier.

In an alternative embodiment, the sulfur reaction product is used directly as the polymer matrix in a composite material. In this embodiment, the method for fabricating the composite material includes:
(a) impregnating a fiber reinforcement layer or infusing a fibrous preform with the sulfur reaction product; and
(b) curing the impregnated fiber reinforcement at an elevated temperature, preferably, for a period of time such that the ratio of the cured reaction enthalpy/uncured reaction enthalpy, as determined by DSC, is less than 0.1 and preferably less than 0.05.

Another aspect of the present disclosure is directed to a liquid resin infusion method or liquid molding method, particularly, Resin Transfer Molding (RTM) and Vacuum-Assisted RTM (VaRTM). In such resin infusion method, the thermoset resin composition containing the sulfur reaction product or the sulfur reaction product, by itself, is formulated so that it has a sufficiently low viscosity for infusion/injection into a fibrous preform.

In RTM, the fibrous preform is placed in a closed mold, which is heated to an initial temperature temperature, e.g., greater than 25° C., in some embodiments, 90° C. to 120° C., followed by injection of the liquid resin composition into the mold to affect infusion of the liquid resin into the preform. The mold may be maintained at a dwell temperature of 20° C. to 220° C. during the infusion of the fibrous preform. The temperature of the mold after infusion is completed to affect curing of the resin-infused preform, thereby forming a hardened composite article. The temperature of the mold after is raised after resin infusion is completed to affect curing of the resin-infused preform, thereby forming a hardened composite article. In VaRTM, the fibrous preform is placed on a one-sided mold enclosed by a flexible vacuum bag and vacuum is applied to pull the liquid resin into the preform. The preform is composed of one or more layers of reinforcement fibers, which are permeable to liquid resin. When the preform is completely infused with the resin composition, the mold temperature is ramped up to a cure temperature, e.g. in the range from 160° C. to 200° C., for a predetermined period of time to allow full curing of the resin composition. The cured product resulting from the described method is a hardened composite article.

Reinforcement fibers that are useful for the purpose disclosed herein include carbon or graphite fibres, glass fibres and fibres formed of silicon carbide, alumina, boron, quartz, and the like, as well as fibres formed from organic polymers such as for example polyolefins, poly(benzothiazole), poly(benzimidazole), polyarylates, poly(benzoxazole), aromatic polyamides, polyaryl ethers and the like, and may include mixtures having two or more such fibres. Preferably, the fibers are selected from glass fibers, carbon fibers and aromatic polyamide fibers, such as the fibers sold by the DuPont Company under the trade name KEVLAR. The reinforcement fibers may be used in the form of chopped or continuous fibers, as tows made up of multiple filaments, as continuous unidirectional or multidirectional tapes, or as woven, non-crimped, or nonwoven fabrics. The woven form may be selected from plain, satin, or twill weave style. The non-crimped fabric may have a number of plies and fiber orientations.

### EXAMPLES

### Example 1

Reaction Product of Sulfur and MDEA 1 g of elemental Sulfur powder and 1 g of MDEA (as a crosslinker material) were hand mixed at room temperature in a small glass vial before being heated to 120° C. for 1 hr with magnetic stirring on a hot plate. After 1 hr at 120° C. the vial was transferred to an oven where it was heated for a further 14 hrs at 140° C. The resulting sulfur-MDEA reaction product (Sample A) was found to be a homogeneous solid red/brown product.

The reaction product was tested for its solubility in MY0510 (triglycidyl ethers of p-aminophenol) from Huntsman Advanced Materials at 80° C. by adding 0.1 g of sulfur-MDEA reaction product to 5 g of MY0510 in an aluminum dish and manually stirring while heating the mixture. The sulfur-MDEA reaction product was found to fully dissolve in MY0510.

### Example 2

### Reaction Product of Sulfur and DGEBF

1 g of elemental sulfur was mixed with 1 g of Araldite® PY306 (diglycidyl ether of Bisphenol F or DGEBF) from Huntsman Advanced Materials and 0.1 g of sodium diethyldithiocarbamate (DDC) as accelerator/compatibilising agent were hand mixed at room temperature in a small glass vial before being heated to 120° C. for 1 hr with magnetic stirring on a hot plate. After 1 hr at 120° C. the vial was transferred to an oven where it was heated for a further 14 hrs at 140° C. The resulting sulfur-DGEBF reaction product (Sample T) was found to be a homogeneous viscous yellow product.

The reaction product was tested for its solubility in MY0510 (triglycidyl ethers of p-aminophenol) at 80° C. by adding 0.1 g of sulfur-DGEBF reaction product to 5 g of MY0510 in an aluminum dish and manually stirring while heating the mixture. The sulfur-DGEBF reaction product was found to fully dissolve in MY0510.

It was found that when 1 g of elemental sulfur was reacted with 1 g of MY0510 (Sample G) under the same conditions described above, the reaction yielded a dark-brown/black two-phase (nonhomogeneous) hard material. The lighter brown areas suggest that unreacted sulfur still remained. The reaction was deemed to be unsuccessful. When 0.1 g of DDC was added to the reaction of 1 g sulfur and 1 g MY0510 (Sample Q), the reaction yielded a nonhomogeneous material with bubbles inside indicating the material had decomposed.

It was found that when 1 g of elemental sulfur was reacted with 1 g of MY721 (N,N,N′,N′-tetraglycidyl-4,4′-methylenebisbenzenamine) from Huntsman Advanced Materials (Sample F) under the same reaction conditions, the reaction yielded a brownish nonhomogeneous solid with flecks of unreacted sulfur throughout the sample. The reaction was deemed to be unsuccessful. When 0.1 g of DDC was added to the reaction of 1 g sulfur and 1 g MY721 (Sample 0), the reaction yielded a homogeneous material with black solids therein indicating that the sample had decomposed. The reaction product was found to be not soluble in MY0510 at 80° C.

### Example 3

Epoxy resin compositions containing MY721, MY0510 and MCDEA (4,4′-methylene-bis-(3-chloro-2,6-diethylaniline)) were prepared according to the formulations shown in Table 1. Amounts are in weight percentage (wt %). Diaminodiphenyl sulfide (AFD), sulfur-MDEA reaction product (prepared according to Example 1), and sulfur-DGEBF (or sulfur-PY306) reaction product (prepared according to Example 2) were added as additives to the unmodified epoxy resin compositions in the amounts shown in Table 1 to form resin samples. The amount (wt %) of additive is based on the combined weight of additive and unmodified resin.

TABLE 1

| | | | | | Additive | Total |
|---|---|---|---|---|---|---|
| Experiment | MY721 | MY0510 | MCDEA | | amount | mass |
| No. | (wt %) | (wt %) | (wt %) | Additive | (wt %) | (wt %) |
| 1 | 40 | 13 | 47 | None | 0 | 100 |
| 2 | 41 | 14 | 42 | Diaminodiphenyl | 3 | 100 |
| | | | | sulfide | | |
| 3 | 43 | 14 | 31 | Diaminodiphenyl | 12 | 100 |
| | | | | sulfide | | |
| 4 | 40 | 13 | 46 | MDEA/Sulfur (A) | 1 | 100 |
| 5 | 38 | 13 | 44 | MDEA/Sulfur (A) | 5 | 100 |
| 6 | 40 | 13 | 46.9 | PY306/Sulfur (T) | 0.1 | 100 |
| 7 | 40 | 13 | 46 | PY306/Sulfur (T) | 1 | 100 |
| 8 | 38 | 13 | 44 | PY306/Sulfur (T) | 5 | 100 |

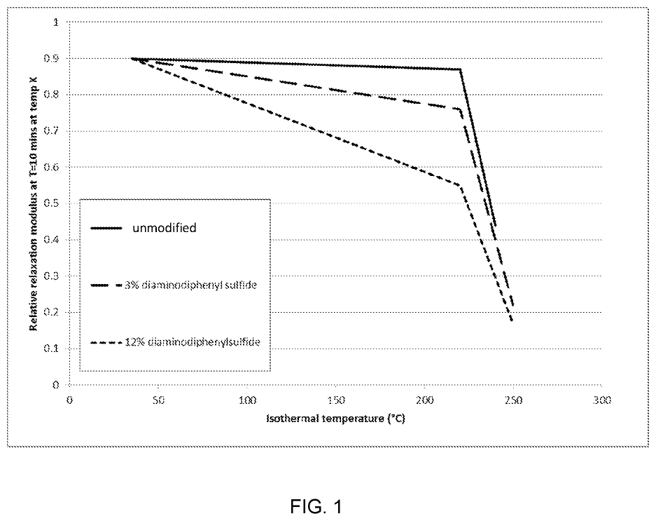

The resin samples were degassed at 80° C. prior to being ramped to cure at 2° C./min target temperature of 180° C. and held for 2 hrs. The cured samples were tested to determine their stress relaxation behavior using TA Instruments Q800 DMA. The results of the stress relaxation test for samples containing diaminodiphenyl sulfide (AFD) are shown in FIG. 1. The data in FIG. 1 shows that the addition of AFD caused a reduction of stress relaxation behavior with higher amount (weight %).

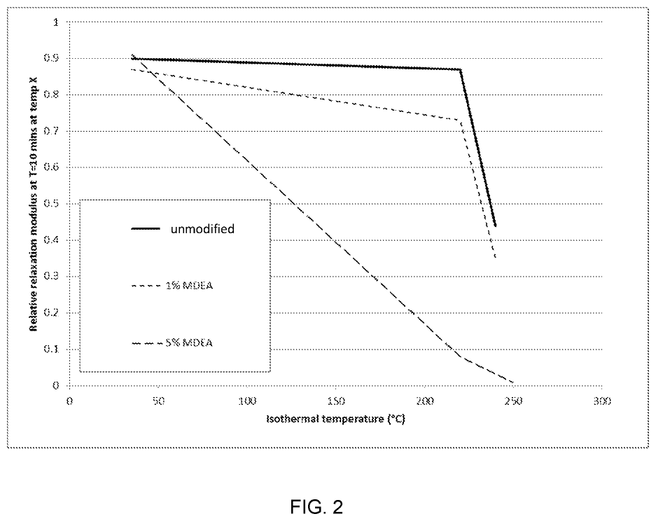

The results of the stress relaxation test for resin samples containing sulfur-MDEA reaction product (prepared in Example 1) are shown in FIG. 2. The data in FIG. 2 shows that the addition of sulfur-MDEA reaction product caused a more rapid reduction of stress relaxation modulus than the addition of AFD at a lower amount (weight %) shown in FIG. 1.

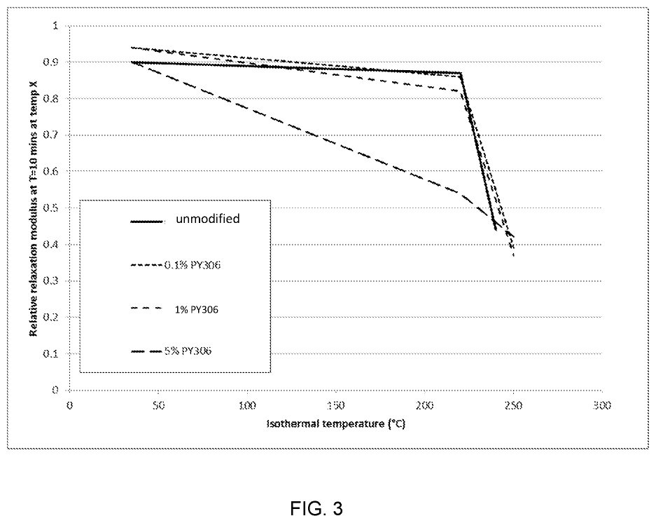

The results of the stress relaxation test for resin samples containing sulfur-PY306 reaction product (prepared in Example 2) are shown in FIG. 3. The data in FIG. 3 shows that the addition of sulfur-PY306 reaction product caused a more rapid reduction of stress relaxation modulus than the addition of AFD at a lower amount (weight %) shown in FIG. 1.

Cured samples (Experiments No. 1 through 8 from Table 1) were also subjected to a conditioning experiment for 8 hrs in refluxing (200° C.) benzyl alcohol to understand the effectivity of the stress relaxation on the recycling potential of the cured materials. The results are shown in TABLE 2 below. These results indicate that the samples prepared from thermosetting resins containing the Sulfur reaction products fractured sooner than the sample prepared from unmodified thermosetting resin and also sooner than the samples prepared from thermosetting resins containing AFD.

TABLE 2

| | | Sample state at t = 8 hrs |
|---|---|---|
| Sample from | | (8 hrs in refluxing benzyl |
| experiment | Sample state at t = 0, RT | alcohol), RT |
| 1 | Dark solid resin sample | Swollen solid sample |
| | | Beginning to fracture |
| 2 | Dark solid resin sample | Swollen solid sample |
| | | Not fractured |
| 3 | Dark solid resin sample | Swollen solid sample |
| | | Not fractured |
| 4 | Dark solid resin sample | Swollen solid sample |
| | | Beginning to fracture |
| 5 | Dark solid resin sample | Swollen solid sample |
| | | Beginning to fracture |
| 6 | Dark solid resin sample | Swollen solid sample |
| | | Not fractured |
| 7 | Dark solid resin sample | Swollen solid sample |
| | | Beginning to fracture |
| 8 | Dark solid resin sample | Swollen solid sample |
| | | Highly fractured |

RT refers to room temperature.

1. (canceled)

2. A sulfur reaction product formed by reacting elemental sulfur with 4,4′-methylene-bis-(2,6-diethylaniline) (MDEA).

3. The sulfur reaction product according to claim 2, wherein the reaction product is formed by mixing sulfur with MDEA, and heating the resulting mixture to a temperature in the range of 100° C. to 200° C. for a duration of greater than 1 hour.

4. The sulfur reaction product according to claim 2, wherein the mass ratio of sulfur to MDEA is from 0.01:1 to 1:1.

5. A sulfur reaction product formed by reacting elemental sulfur with an epoxy compound having at least one epoxy functional group per molecule and a compatibilising agent.

6. The sulfur reaction product according to claim 5, wherein the epoxy compound is diglycidyl ether of Bisphenol F (DGEBF).

7. The sulfur reaction product according to claim 5, wherein the compatibilising agent is sodium diethyldithiocarbamate (DDC).

8. The sulfur reaction product according to claim 7, wherein the reaction product is formed by mixing sulfur with DGEBF and the compatibilising agent, and heating the resulting mixture to a temperature in the range of 100° C. to 200° C. for a duration of greater than 1 hour.

9. The sulfur reaction product according to claim 6, wherein the mass ratio of sulfur to DGEBF is from 0.01:1 1:1, and the amount of compatibilising agent is up to 20 parts in weight, per 100 parts in weight of sulfur and DGEBF combined.

10. A curable resin composition comprising one or more epoxy resins, at least one amine curing agent, and the sulfur reaction product according to claim 2.

11. A curable composite material comprising reinforcement fibers that are fully or partially embedded in a resin matrix comprising one or more epoxy resins and the sulfur reaction product according to claim 2.

12. A composite material comprising reinforcement fibers and the sulfur reaction product according to claim 2.

13. A thermoset prepreg comprising a layer of unilateral reinforcement fibers embedded in a curable resin matrix comprising one or more uncured epoxy resins and the sulfur reaction product according to claim 5.

14. A method for fabricating a composite material, comprising:
(a) adding the sulfur reaction product of claim 2 into an uncured thermosettable resin composition comprising one or more thermoset resins;
(b) impregnating a fiber reinforcement layer or infusing a fibrous preform with the thermosettable resin composition formed from step (a); and
(c) curing the impregnated fiber reinforcement at an elevated temperature, preferably, for a period of time such that the ratio of the cured reaction enthalpy/uncured reaction enthalpy, as determined by Differential Scanning calorimetry (DSC), is less than 0.1.

15. The method of claim 14, wherein the thermosettable resin composition at step (a) comprises one or more epoxy resins and at least one amine curing agent.

16. A method for fabricating a composite material, comprising:
(a) impregnating a fiber reinforcement layer or infusing a fibrous preform with the sulfur reaction product according to claim 2; and
(b) curing the impregnated fiber reinforcement at an elevated temperature, preferably, for a period of time such that the ratio of the cured reaction enthalpy/uncured reaction enthalpy, as determined by Differential Scanning calorimetry (DSC), is less than 0.1.

17. (canceled)

18. (canceled)

19. A curable resin composition comprising one or more epoxy resins, at least one amine curing agent, and the sulfur reaction product according to claim 5.

20. A curable composite material comprising reinforcement fibers that are fully or partially embedded in a resin matrix comprising one or more epoxy resins and the sulfur reaction product according to claim 5.

21. A composite material comprising reinforcement fibers and the sulfur reaction product according to claim 5.

22. A method for fabricating a composite material, comprising:
(a) adding the sulfur reaction product of claim 5 into an uncured thermosettable resin composition comprising one or more thermoset resins;
(b) impregnating a fiber reinforcement layer or infusing a fibrous preform with the thermosettable resin composition formed from step (a); and
(c) curing the impregnated fiber reinforcement at an elevated temperature for a period of time such that the ratio of the cured reaction enthalpy/uncured reaction enthalpy, as determined by Differential Scanning calorimetry (DSC), is less than 0.1.

23. A method for fabricating a composite material, comprising:
(a) impregnating a fiber reinforcement layer or infusing a fibrous preform with the sulfur reaction product according to claim 5; and
(b) curing the impregnated fiber reinforcement at an elevated temperature, preferably, for a period of time such that the ratio of the cured reaction enthalpy/uncured reaction enthalpy, as determined by Differential Scanning calorimetry (DSC), is less than 0.1.
